(19) United States
(12) Patent Application Publication
(10) Pub. No.: US 2006/0288749 A1
(43) Pub. Date: Dec. 28, 2006

(54) Inedible egg compositions and methods for organic fertilization of plants

(76) Inventor: Edgar N. Drake III, Winters, TX (US)

Correspondence Address: JACKSON WALKER LLP, 901 MAIN STREET, SUITE 6000, DALLAS, TX, 75202-3797, US

(21) Appl. No.: 11/472,853

(22) Filed: Jun. 22, 2006

Related U.S. Application Data
(60) Provisional application No. 60/693,010, filed on Jun. 22, 2005.

(51) Int. Cl. C05F 3/00

(52) U.S. Cl. 71/15

(57) ABSTRACT

A fertilizer composition having as its principal component inedible egg product that has been classified as unfit for human consumption. The inedible egg product is pasteurized and may be dried into powder form or utilized as a liquid. The fertilizer composition may be organic and may optionally contain additional components. In dried form, the organic fertilizer composition can be tilled directly into the soil. Because it utilizes inedible egg product, the organic fertilizer composition has several advantages compared to traditional organic fertilizers, particularly a short release time, cost-effectiveness, lack of undesirable residual components, and availability.

This application claims priority to U.S. Provisional Patent Application Ser. No. 60/693,010, entitled “Inedible Egg Compositions and Methods for Organic Fertilization of Plants,” filed on Jun. 22, 2005, the entire content of which is hereby incorporated by reference.

### BACKGROUND

This invention pertains to an organic fertilizer, and particularly to an organic fertilizer comprising inedible egg materials and its methods of use.

The term fertilizer refers to a soil amendment that guarantees minimum percentages of nutrients, and particularly at least a minimum percentage of nitrogen, phosphate, and potash. An organic fertilizer is a soil amendment that is derived from natural sources and that guarantees at least a minimum percentage of nitrogen, phosphate, and potash (Whiting, et al., 2005).

The importance of organic fertilizers has increased significantly in recent years due to growing public demand for organic food products and the general backlash against the use of excessive chemicals in the agriculture industry. However, organic fertilizers are often not as efficient as other synthetic fertilizers. Organic fertilizer products depend on the activity of soil microorganisms to break down the fertilizer before the nutrients are available for plant uptake. The period known as release time is the time required for the nutrients in organic fertilizers to be converted to a chemical form that can be assimilated by plants. Typically, organic fertilizers are slow-acting because their release times vary from one to four months.

In addition, organic fertilizers, while derived from natural sources, often contain undesirable components such as weed seeds (present in alfalfa meal or pellets), germination inhibitors (present in corn gluten meal), pesticide residues (present in cottonseed meal), or pathogenic bacteria (present in manure). Some organic fertilizers, such as blood meal, can burn plants with excessive ammonia if over-applied. Other organic fertilizers, such as acid or heat-processed fish waste liquid, find limited application because of their characteristic foul smell. In some instances, such as with blood and bone meal, the cost of the product precludes its extensive use.

One example of an organic fertilizer that is sometimes utilized is the egg shell, which is rich in calcium carbonate. U.S. Pat. No. 6,176,376 to MacNeil teaches a method for separating the residual contents of an egg from waste egg shells. MacNeil points out that a survey conducted in 1997 indicated that about 26.6% of waste egg shell product was used as fertilizer.

The use of other egg products as organic fertilizer has not been described. U.S. Pat. No. 5,582,627 to Yamashita discloses a nutrient medium and method for stimulating the growth of micro-organisms in soil, particularly after contamination with chemicals. Eggs are described as being a potential ingredient in the composition, but their effectiveness as an organic fertilizer is not described. U.S. Pat. No. 4,394,149 to Szoka, Jr. et al. teaches a plant nutriment composition that is encapsulated in a lipid vesicle. Szoka states that preferred compounds for the lipid vesicle wall include compounds such as phosphatidylcholine, phosphatidic acid, phosphatidylglycerol, and phosphatidylethanolamine, all of which can be derived from purified egg yolk. However, Szoka does not describe the use of egg yolk as part of the nutriment composition.

The United States Department of Agriculture mandates that a large fraction of eggs be classified as unsuitable for human consumption, or inedible. Inedible eggs are defined to include those whole raw eggs, hard boiled eggs, egg yolks, egg albumen, and all other liquid or dry egg fractions that the United States Department of Agriculture (“USDA”) has mandated cannot be used in human foods or for human consumption. According to the USDA Egg Market News Report for the week ending May 28, 2005, the year-to-date total of USDA-inspected available liquid egg was 639,392,000 pounds. About 14.5% of this liquid egg product, or 92,804,000 pounds, was classified as inedible.

### SUMMARY

The present invention relates to an organic fertilizer composition containing as its principal ingredient inedible egg product.

Inedible eggs are defined to include those whole raw eggs, hard boiled eggs, egg yolks, egg albumen, and all other liquid or dry egg fractions that the United States Department of Agriculture (“USDA”) has mandated cannot be used in human foods or for human consumption. Often the eggs that become classified as inedible eggs are cracked, dirty, or misshapen. The USDA requires that all eggs classified as unfit for human consumption be injected with a denaturant dye that clearly indicates the egg is inedible. U.S. Pat. No. 6,348,223 to Claycamp et al., the entire content of which is hereby incorporated by reference, pertains to the use of inedible egg product as a milk replacer composition.

The organic fertilizer composition comprising inedible liquid egg product has a shorter release time and contains none of the undesirable components present in prior organic fertilizers. Inedible egg product provides a source of nitrogen to plants almost immediately, and even if it is applied excessively, it does not appear to have a burning effect on plants. In addition, the current organic fertilizer compositions are cost competitive when compared with other organic fertilizers, particularly because they utilize a type of egg product that is typically considered waste. Pasteurization of the inedible egg product that is utilized in the organic fertilizer compositions kills any microorganisms that might cause disease, spoilage, or undesired fermentation. The organic fertilizer compositions can utilize inedible egg product in liquid or dry form.

In general, the current invention pertains to an organic fertilizer composition comprising inedible egg product in a liquid or powdered form, in an amount ranging from about 1% to about 100% by weight. The fertilizer can be tilled directly into the soil as a powder or dispersed as a liquid. The organic fertilizer may optionally contain additional nutrient-rich components. The current invention also pertains to methods of using the organic fertilizer composition. The organic fertilizer composition effectively promotes the growth of treated plants by providing a source of nutrients in the form of egg product. Because the inedible egg product is classified as unsafe for human consumption, it is cost-effective and readily available for use in the organic fertilizer composition.

### DETAILED DESCRIPTION OF PREFERRED EMBODIMENTS

The present invention relates to an organic fertilizer composition comprising inedible egg product as its principal ingredient.

The term “inedible egg product” as used herein broadly refers to any and all types of inedible eggs which are classified as unsafe for human consumption and to which a denaturant dye has been added in conformance with USDA requirements, codified at §1039 of the Egg Products Inspection Act, U.S. Code Title 21, Chapter 15. The inedible egg product which is suitable for use with the present organic fertilizer composition can be obtained by the following method. Eggs already classified as inedible or those destined to be classified as inedible are obtained, their shells are broken, and a denaturant dye is added to clearly indicate that the egg product is not meant for human consumption. Any denaturant dye suitable in the industry and acceptable to the USDA, which is known not to affect the nutritional value of the egg, can be used. Next, the egg shells are removed from the liquid egg product by centrifugation or any other method suitable for removing egg shell debris from the liquid egg product.

The liquid inedible egg product is then held in refrigerated storage tanks at or below about 45° F. until it can be pasteurized. The term “pasteurization” means the process of subjecting egg products to heat or other treatments to destroy harmful viable micro-organisms. Preferably, the liquid egg product is pasteurized using heat in a pasteurization unit. After the liquid egg product is delivered to the pasteurization unit, the unit heats the inedible liquid egg to abut 140° F. and holds it at that temperature for a minimum of about 4.5 minutes to kill all pathogens and other spoilage-inducing organisms.

After pasteurization, the liquid inedible egg product may be dried to produce a powder. If the inedible egg product is to be dried, it must be dried immediately or remain refrigerated until dried. Preferably, the dried inedible egg product is prepared by spray drying, but it may also be dried according to any method known in the art. If prepared by spray drying, an anti-caking agent should be added to the inedible egg product to prevent the formation of hard lumps during storage. The dried inedible egg product preferably contains from about 2 to about 5 percent moisture and should be stored in water-tight or air-tight containers for sale and storage. If the inedible egg product is to remain in liquid form, it should be kept under refrigeration until it is packaged in water-tight or air-tight containers, and it must be refrigerated during any storage periods thereafter.

One aspect of the current invention is an organic fertilizer composition comprising inedible egg product in an amount ranging from about 1% to about 100% by weight, and more preferably from about 70% to about 100% by weight, based on the total weight of the organic fertilizer composition. Optionally, the organic fertilizer composition may further comprise any additional components known in the art as being suitable for fertilizer compositions, in an amount ranging from about 1% to about 30% by weight, based on the total weight of the organic fertilizer composition. Examples of additional components include, but are not limited to, proteins, lipids, carbohydrates, and micronutrients including trace elements or minerals that are consistent with organic fertilizer compositions. In particular, the organic fertilizer composition may further comprise additional components selected from the group consisting of phosphorus and potassium compounds, or any combination thereof, in a naturally occurring chemical form. Additional components which may be added to the organic fertilizer composition, except for USDA-approved components, must be in a naturally occurring form in order for the composition to qualify as an organic fertilizer.

In some instances, additional components may be added to the fertilizer composition which are not in a naturally occurring chemical form. Although the addition of some synthetic components may prevent the fertilizer composition from being classified as “organic,” the addition of these synthetic components in no way diminishes the effectiveness of the fertilizer composition. Furthermore, the current fertilizer composition could use edible egg product rather than inedible egg product, as either type of egg product is expected to have comparable nutritional value and effectiveness as a fertilizer.

In one preferred embodiment of the organic fertilizer composition, inedible egg product is combined with potassium sulfate. To prepare the organic fertilizer composition, solid, naturally occurring potassium sulfate is added to and mixed uniformly with the dried inedible egg product so that the amount of potassium sulfate contributes 5% by weight of the organic fertilizer composition, based on the total weight of the composition, and the remaining 95% by weight is composed of the dried inedible egg product.

The organic fertilizer composition may be in dried or liquid form. If the organic fertilizer composition is in dried form, it can be pelletized or unpelletized. If the organic fertilizer composition is in dried form, it can be tilled directly into the soil or suspended in various liquids or solutions for spray application. For example, the fertilizer composition can be suspended in water. If the organic fertilizer composition is in liquid form, it can be diluted, and applied as a spray. The effectiveness of the fertilizer is not diminished by dispersion into water, and any effective concentration of the spray can be used.

The proper amount of organic fertilizer to be applied will vary from application to application, depending on the user's needs, as recognized by those of skill in the art with regard to any organic fertilizer. In one preferred embodiment, the amount of organic fertilizer composition, comprising 100% dried inedible egg product powder, that should be applied is from about 2400 to about 2500 pounds of fertilizer per acre of soil. Because commercially available dried inedible egg product is guaranteed to contain no less than 7% nitrogen, this will provide about 170 pounds of nitrogen per acre. For small quantities of soil, such as those used for potting flowers, the corresponding amount of organic fertilizer comprising 100% dried inedible egg product powder is about one tablespoon per gallon of soil.

In an additional preferred embodiment, the organic fertilizer composition comprising inedible egg product can be dissolved or suspended in water for the fertilization of hydroponically-grown plants. In this embodiment, the amount of inedible egg product is preferably used in the organic fertilizer in an amount providing about 0.00081 pounds of nitrogen for each gallon of hydroponic solution to be fertilized. Depending on the volume of the hydroponic solution being used, and knowing that commercially available inedible egg product typically contains no less than 7% nitrogen, the correct amount of fertilizer for each hydroponic application can be calculated. Dried inedible egg product can be used as the basis for the organic fertilizer in lieu of liquid inedible egg product so long as uniform distribution of the dried egg powder is maintained. The organic fertilizer composition, comprising 100% dried inedible egg product can be applied in an amount of about one tablespoon for each gallon of hydroponic solution to be fertilized.

A further preferred embodiment pertains to a method for increasing the growth of plants comprising treating the plants or the soil to be fertilized with an effective amount of the organic fertilizer composition. As used herein, the term “treat” broadly refers to any method by which the organic fertilizer composition is brought into contact with the plant or soil that is being fertilized. Treatment may include spraying, dripping, or pouring the liquid organic fertilizer composition directly onto the plant or soil. Treatment may also include sifting, mixing, or otherwise dispersing the dried organic fertilizer composition, in pellet or powder form, into or around the soil in which the plants to be fertilized will be planted. Treatment of the soil with the dried organic fertilizer composition can also be carried out subsequent to planting. A combination of treatments with both the liquid and the dried organic fertilizer composition is also an option.

Use of the organic fertilizer composition comprising inedible egg product avoids the application of weed seeds, germination inhibitors, pesticide residues, pathogenic bacteria, and offensive smells that are problematic with prior organic fertilizers. In addition, the compositions of the present invention have shorter release times than most of the prior art organic fertilizers. Moreover, the inedible egg product used in the organic fertilizer composition has the added benefit of providing abundant amounts of micronutrients while being cost-competitive with prior products. The organic fertilizer composition may be utilized with any plant varieties that require, or would benefit from, fertilization. The cost-effective nature of the organic fertilizer composition makes it ideal for use in large scale crop production, but its effectiveness extends to small scale gardens or individually potted plants as well.

### EXAMPLE 1

### Fertilization of Tomato Plants

Six commercial tomato plants (Champion variety) were chosen on the basis of their uniform size and health. Each plant was grown in a medium consisting of equal weights of commercial potting soil and native soil excavated in Runnels County, Texas. Plant containers provided 78.5 square inches of soil surface with a depth of 7 inches. Three of the six plants additionally received 14 grams (approximately 3 tablespoons) of commercially available pasteurized inedible egg product powder purchased from Rose Acre Farms (Seymour, Ind.). The inedible egg powder as mixed into the growth medium as uniformly as possible prior to planting the tomato plant in the growth medium. The three plants which did not receive treatment with the dried edible egg powder served as controls. Plant heights of all plants were measured and recorded weekly. In addition, initial flower onset (open bloom) and fruit formation were recorded for comparison. Data were collected for eight weeks, and mean plant heights for the fertilized and control groups are presented below in Table 1.

TABLE 1
Mean Plant Heights for Fertilized and Unfertilized Tomato Plants

| Growth Day Number | Fertilized Plants (in.) | Unfertilized Plants (in.) |
|---|---|---|
| 0 | 7.54 | 7.17 |
| 7 | 11.42 | 10.63 |
| 14 | 14.83 | 12.67 |
| 21 | 19.33 | 14.08 |
| 28 | 24.58 | 17.50 |
| 35 | 31.42 | 23.17 |
| 42 | 37.83 | 29.33 |
| 49 | 41.75 | 37.00 |
| 56 | 43.92 | 40.33 |

The observed difference in mean plant height reached statistical significance at the 95% confidence level by day 14. For the fertilized tomato plants, initial onset of flower formation occurred on day 31, compared with that of the unfertilized plants occurring on day 38. The initial appearance of tomatoes occurred on day 37 in the fertilized plants and never occurred in the unfertilized plants by the end of the experimental period. The experiment was terminated at the end of eight weeks when it was determined that fertilizer availability in the treated plant containers had been materially diminished by the growing plants.

The results indicate that the organic fertilizer composition effectively increases the growth and stimulates the flowering and fruit production of tomato plants.

Based on the results of Example 1, the organic fertilizer composition is effective when applied to soil in an amount providing 172 pounds of nitrogen per acre. This calculation is based on the fact that, in Example 1, 3 tablespoons, or 14 grams, of organic fertilizer composition was added to 78.5 in² of soil. The organic fertilizer composition contained 100% dried inedible egg product, which was obtained cormnercially and guaranteed to contain no less than 7% nitrogen. Because an acre consists of 43,560 ft^{2,} it can be extrapolated that 2,464 pounds of dried inedible egg product can be applied per acre to obtain the favorable results of Example 1. The resulting 2,464 lbs/acre of dried inedible egg product can be converted to pounds of nitrogen per acre by multiplying by 0.070, to produce the figure of 172 pounds of nitrogen per acre.

Based on the results of Example 1, the organic fertilizer composition is also effective when applied to hydroponic solutions in an amount providing 0.00081 pounds of nitrogen per gallon of solution. This calculation is based on the fact that, in Example 1, 14 grams, or 0.0308 pounds, of organic fertilizer composition was added to 78.5 in² or 2.68 gallons, of soil. The resulting ratio of 0.011 pounds of fertilizer per gallon of solution produces an effective amount of 0.00081 pounds of nitrogen per gallon. The organic fertilizer composition contained 100% dried inedible egg product, which was obtained commercially and guaranteed to contain no less than 7% nitrogen.

### REFERENCES CITED

The following U.S. Patent documents and publications are hereby incorporated by reference.

### U.S. Patent Documents

U.S. Pat. No. 4,394,149 to Szoka, Jr. et al.
U.S. Pat. No. 5,582,627 to Yamashita
U.S. Pat. No. 6,176,376 to MacNeil
U.S. Pat. No. 6,348,223 to Claycamp et al.

### Other Publications

Whiting, D. et al., Organic Fertilizers, Colorado State University Cooperative Extension Horticulture (March 10, 2005).

What is claimed is:

1. A fertilizer composition comprising inedible egg product.

2. The fertilizer composition of claim 1, wherein the inedible egg product ranges from about 1% to about 100% by weight of the organic fertilizer composition.

3. The fertilizer composition of claim 1, further comprising an additional component in a naturally occurring form, wherein the additional component is selected from the group consisting of proteins, lipids, carbohydrates, micronutrients, and mixtures thereof.

4. The fertilizer composition of claim 1, further comprising an additional component in a naturally occurring form, wherein the additional component is selected from the group consisting of phosphorus compounds, potassium compounds, and mixtures thereof.

5. The fertilizer composition of claim 1, further comprising an additional component in a USDA-approved synthetic form.

6. The fertilizer composition of claim 1, wherein the inedible egg product ranges from about 70% to about 100% by weight of the organic fertilizer composition.

7. The fertilizer composition of claim 1, wherein the inedible egg product is in a dried form.

8. The fertilizer composition of claim 1, wherein the inedible egg product is in a liquid form.

9. The fertilizer composition of claim 1, wherein the fertilizer composition is in a dried form.

10. The fertilizer composition of claim 9, wherein the fertilizer composition is in a powder form, a pellet form, or a mixture thereof.

11. The fertilizer composition of claim 1, wherein the fertilizer composition is in a liquid form.

12. The fertilizer composition of claim 11, further comprising water.

13. The fertilizer composition of claim 1, wherein the fertilizer composition is an organic fertilizer composition.

14. A method for increasing the growth rate of plants comprising:
treating the plants with the fertilizer composition of claim 1.

15. A method for increasing the growth rate of plants comprising:
mixing the fertilizer composition of claim 1 with a portion of growth medium to produce a treated growth medium; and
cultivating the plants in the treated growth medium.

16. The method of claim 15, wherein the growth medium is soil or dirt.

17. A method for increasing the growth rate of plants comprising:
spraying the plants with the organic fertilizer composition of claim 1, wherein the fertilizer composition is in liquid form.

18. A method for increasing the growth rate of hydroponically-grown plants in hydroponic solution comprising:
mixing the fertilizer composition of claim 1 with the hydroponic solution to produce a treated hydroponic solution; and
cultivating the hydroponically-grown plants in the treated hydroponic solution.
